(19) United States
(12) Patent Application Publication
(10) Pub. No.: US 2003/0084140 A1
(43) Pub. Date: May 1, 2003

(54) Data relay method

(75) Inventors: Tadashi Takeuchi, Yokohama (JP); Damien Le Moal, Sagamihara (JP); Ken Nomura, Yokohama (JP)

Correspondence Address: McDermott, Will & Emery, 600, 13th Street, N.W., Washington, DC, 20005-3096, US

(73) Assignee: Hitachi, Ltd.

(21) Appl. No.: 10/116,210

(22) Filed: Apr. 5, 2002

(30) Foreign Application Priority Data
Oct. 26, 2001 (JP) 2001-328507

(51) Int. Cl. G06F 15/173

(52) U.S. Cl. 709/223

(57) ABSTRACT

In a system having servers, clients and a load balancing node interconnected via a network, prior to transmitting a service execution request from a client to the node balancing node, a request for reserving server resources necessary for the service execution is transmitted to the load balancing node. The load balancing node manages the total amount of server resources presently reserved. The load balancing node selects the server having a room of assigning the requested server resources. When the service execution request is received from the client, the load balancing node transmits the request to the selected server.

### BACKGROUND OF THE INVENTION

1. Field of the Invention

The present invention relates to a data relay method, and more particularly to a data relay method and system capable of guaranteeing the quality of services provided to each client by properly realizing load distribution among a server group which provides services to a client group.

2. Description of the Related Art

JP-A-2001-101134 discloses a method of guaranteeing the quality of services provided to each client by properly distributing loads on a server group which provides services to a client group.

According to this method, all requests and responses transferred between client and server groups are relayed by a load distributing or balancing apparatus interposed between the client and server groups. A server directing apparatus is installed near the load distributing apparatus. The server directing apparatus monitors the contents of requests and responses and transfer times by capturing packets.

When a request is received from a client, the load distributing apparatus inquires the server directing apparatus about the server most suitable for transferring the request.

The server directing apparatus predicts a load of each server for providing each service and the current load state of each server by simulation using the contents of past transferred requests (the types of past services provided by servers) and the transfer times taken to return responses to past requests (times taken to provide services from servers). The server currently having a largest load margin is notified as the optimum server to the load distributing apparatus.

Upon reception of this notice, the load distributing apparatus transfers the request from the client to the server designated by the notice.

### SUMMARY OF THE INVENTION

The above-described method has the following problems.

1) Prediction of a load of each server is not precise. For example, an increase degree of the time required for providing services is different between when the bandwidth of a disc used by a server for providing services broadens and when the CPU time becomes long. Therefore, in order to judge whether a server has a room for receiving a request (whether the time required for providing services becomes much longer if the request is received), it is necessary to monitor the states of various resources (the bandwidth of a used disc, the bandwidth of a used network, the CPU use time). However, the above-described method does not perform this monitor.

2) Different service qualities cannot be set to clients. For example, it is not possible that the service quality is guaranteed for a client which pays a value for services provided, whereas the service quality is not guaranteed for a client which does not pay a value.

3) The guarantee of service quality is insufficient. When a server provides services to a client for which the service quality is guaranteed, it is necessary to guarantee that various resources (the bandwidth of a used disc, the bandwidth of a used network, the CPU use time) of the server necessary for services are assigned. The above-described method does not perform this assignment.

It is an object of the present invention to solve the above-described three problems and provide a data relay method capable of: A) correctly predicting the load of each server by making each server monitor the use state of each of various resources (the CPU use time, the bandwidth of a used disc, the bandwidth of a used network); B) setting a priority degree of the quality of services to be provided to each client; and C) allowing a server to guarantee assignment of various resources necessary for services when the server provides the services to the client having the guaranteed quality of services.

In the system having a plurality of servers and clients and a load balancing node interconnected via a network, after the load balancing node receives a service execution request from a client, the load balancing node transmits the service execution request to one of the servers, and the server received the service execution request transmits the execution results of services to the client. In this system, the invention provides a data relay method which is characterized in that:

1) Prior to transmitting a service execution request from a client, a request for reserving server resources necessary for the service execution is transmitted to the load balancing node;

2) The load balancing node manages the total amount of server resources presently reserved. The load balancing node selects the server having a room of go assigning the requested server resources;

3) When the service execution request is received from the client, the load balancing node transmits the request to the server selected at 2);

4) The load balancing node notifies the amount of server resources requested for reservation by the client; and

5) The server executes services requested by the client by using the resource amount notified at 4).

### BRIEF DESCRIPTION OF THE DRAWINGS

FIG. 1 is a diagram showing the structure of a system according to an embodiment of the invention.

FIG. 2 shows the data structure of a server resource management table.

FIG. 3 shows the data structure of a client management table.

FIG. 4 shows the data structure of a cache management table.

FIGS. 5A to 5D show the data structures of requests and responses to be transferred between nodes.

FIGS. 6A to 6C show the data structures of commands to be transferred between nodes.

FIG. 7 is a flow chart illustrating a client operation.

FIGS. 8 and 9 are flow charts illustrating the operation to be executed by a load distributing node.

FIG. 10 is a flow chart illustrating the operation to be executed by a server.

FIG. 11 is a flow chart illustrating the operation to be executed by an I/O engine.

### DETAILED DESCRIPTION OF THE EMBODIMENTS

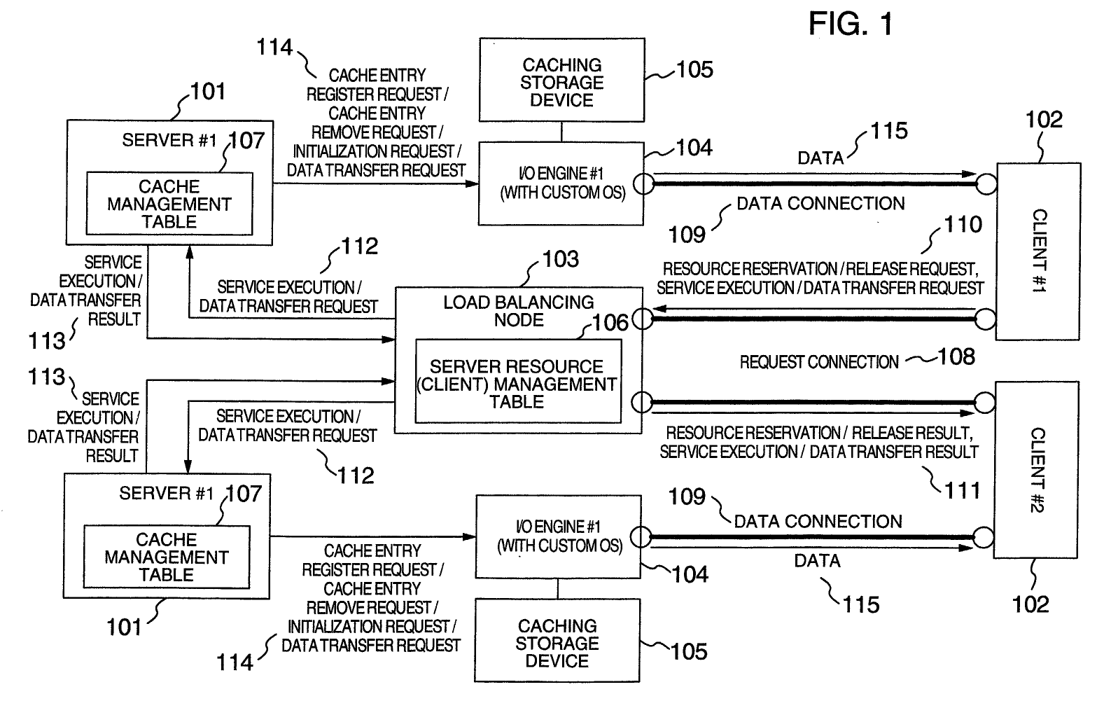

FIG. 1 shows the structure of a system according to an embodiment of the invention.

A client #1 102 and a client #2 102 receive services provided by a server #1 and a server #2 101. Each server is connected to an I/O engine 104 having a caching storage device 105.

The I/O engine 104 connected to each server reads data from the caching storage device 105 and transmits it to the client to allow the sever to provide services. In order to realize a data transfer agency by the I/O engine 104, the server issues a cache entry register command (a command to store data beforehand in the caching storage unit 105) to the I/O engine 104. The server has a cache management table 107 so that it can judge whether the I/O engine 104 of the server caches what data. The I/O engine 104 has a custom OS. This custom OS provides a function of reserving resources (disc bandwidth, network bandwidth, CPU time and the like) necessary for data transfer and a function of transmitting data by using the reserved resources. The custom OS of the I/O engine 104 assigns each client with resources dedicated to the client. Each client can receive data using the assigned resources.

A load distributing or balancing node 103 is a relay apparatus for directing various requests from clients to servers. The load balancing node directs various requests in order to prevent an overload of the I/O engine 103 of each server. The load balancing node 103 has a server resource management table 106 to monitor the total amount of resources which the I/O engines 104 can provide and the current use amount of each resource. As the total amount, a value predicted from the machine configuration of the I/O engine 104 is set beforehand. The use amount is predicted from resource reservation/release requests from the clients to be described later.

The load balancing node 103 directs various requests to prevent the use amount of each resource from exceeding a certain amount.

Request directing may be performed by giving a priority degree to each client (by changing the quality of services to be guaranteed for each client). In this case, the load balancing node 103 is required to manage the client management table 106 and the quality of services to be guaranteed for each client.

The client has a request connection 108 established relative to the load balancing node 103. Via this request connection, the client issues resource reservation and release requests (a reservation request for resources necessary for transferring data of service execution results and a release request) 110 and service execution and data transfer requests (a request for service execution of a server and a request for transferring data of service execution results) 110. The client also has a data connection 109 established relative to the I/O engine 104. Via this connection, data 115 of service execution results is transferred.

Upon reception of the resource reservation request or resource release request from the client, the load balancing node 103 updates the server resource management table and client management table. The load balancing node monitors the resource use amount of each I/O engine and the quality of services of each client. The results of resource reservation or resource release are returned to the client as a resource reservation result or resource release result 111.

Upon reception of the service execution request or data transfer request, the load balancing node 103 transmits the request to the server. The execution results of these requests are transmitted (112) as a service execution result and a data transfer result from the server to the load balancing node 113 and from the load balancing node to the client 111.

Upon reception of the service execution request, the server performs a service execution. After the service execution is completed, the server supplies a cache entry register command/cache entry remove command 114 to the I/O engine 104. Upon reception of this command, the I/O engine 104 stores the service execution result in the caching storage device 105. The server supplies an initialization command to the I/O engine 104. Upon reception of the command, the I/O engine 104 executes an initialization process (data connection establishment and the like) necessary for data transfer.

Upon reception of the data transfer request, the server supplies a data transfer command 114 to the I/O engine 104. Upon reception of this command, the I/O engine 104 transmits data to the client.

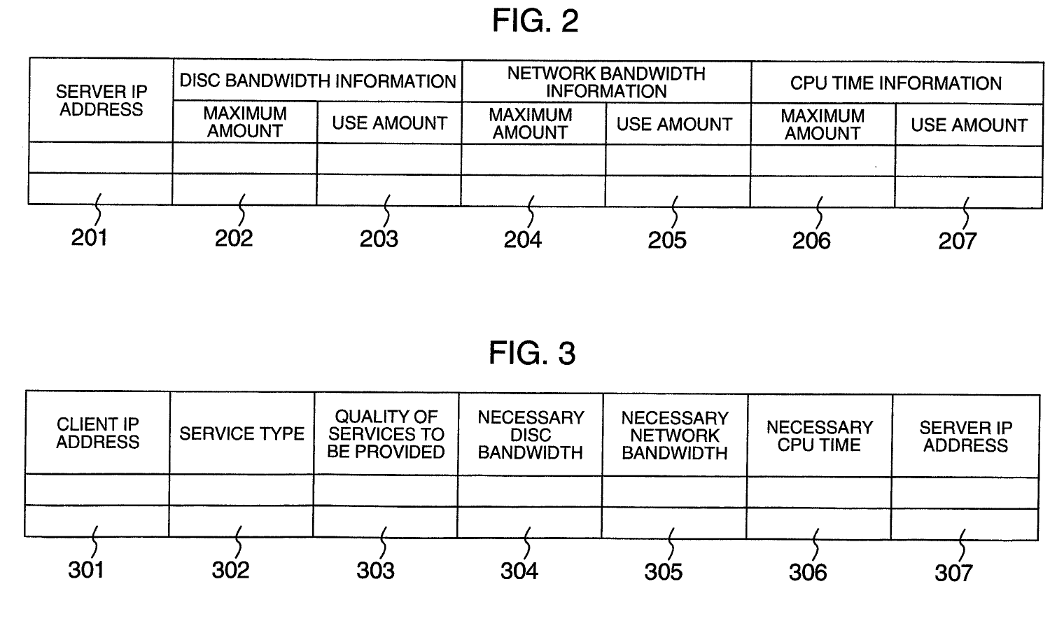

FIG. 2 shows the data structure of the server resource management table 106.

The server resource management table 106 stores a server IP address 201 and information 202 to 207 of resources of the I/O engine 104 of each server. The information of the resources of the I/O engine 104 includes the maximum amount (usable maximum resource amount) and a use amount (current use amount) of each of a disc bandwidth, a network bandwidth and a CPU time.

The information of the “maximum amount” stores beforehand a value predicted from the machine configuration of the I/O engine. The information of the “use amount” is updated at each event of a resource reservation request or resource release request from the client as will be later described.

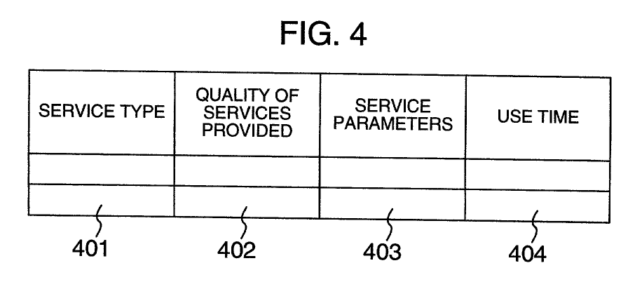

FIG. 3 shows the data structure of the client management table 106. The client management table stores a client IP address 301 and information 302 to 307 of the service contents to be provided to each client. The information of the service contents to be provided includes a service type (the type of services to be provided), the quality of services to be provided (the guaranteed quality of services to be provided), a necessary disc bandwidth, necessary network bandwidth and necessary CPU time (disc bandwidth, network bandwidth and CPU time necessary for transferring data of the service execution result), and a server IP address (IP address of the server to which the request from each client is transferred).

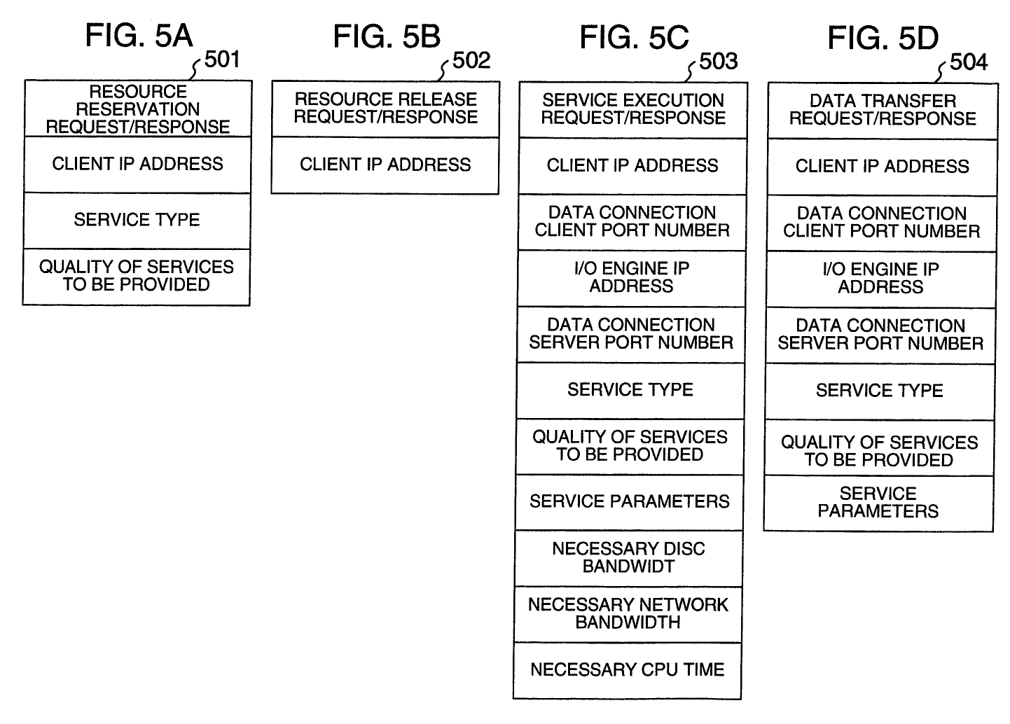

FIG. 4 shows the data structure of the cache management table 107. The cache management table 107 stores information 401 to 403 for identifying the cache contents and a cache use time 404. The information for identifying the cache contents is, for example, the type of services provided, the quality of services provided, and service parameters (various parameters for designating the details of the contents of services provided).

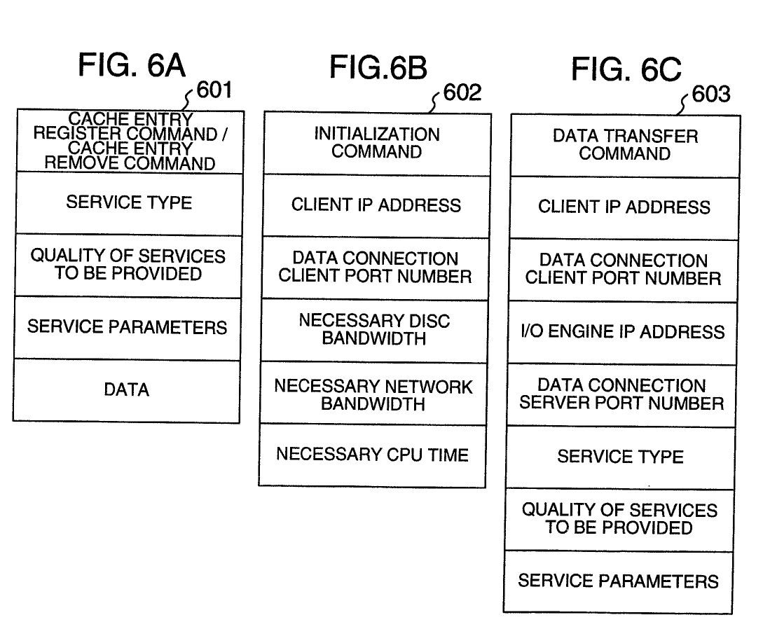

FIGS. 5A to 5D show the data structures of the resource reservation request, resource reservation response, resource release request, resource release response, service execution request, service execution response, data transfer request and data transfer response 110 to 113.

The resource reservation request (response) 501 is constituted of: a field for distinguishing between the resource reservation request and response; a client IP address; and a service type and the quality of services (the type of services requested by a client and the quality of services to be provided).

The resource release request (response) 502 is constituted of: a field for distinguishing between the resource release request and response; and a client IP address.

The service execution request (response) 503 is constituted of: a field for distinguishing between the service execution request and response; a client IP address and a data connection client port number (for designating the terminal point of the data connection on the client side); an I/O engine IP address and a data connection server port number (for designating the terminal point of the data connection on the I/O engine side); a service type, the quality of services to be provided, and service parameters (for designating the service contents requested by the client); and a necessary disc bandwidth, a necessary network bandwidth and a necessary CPU time (the amount of resources of the I/O engine necessary for transmitting data of requested service execution results).

The data transfer request (response) 504 is constituted of: a field for distinguishing between the data transfer request and response; a client IP address and a data connection client port number; an I/O engine IP address and a data connection server port number; and a service type, the quality of services provided, and service parameters.

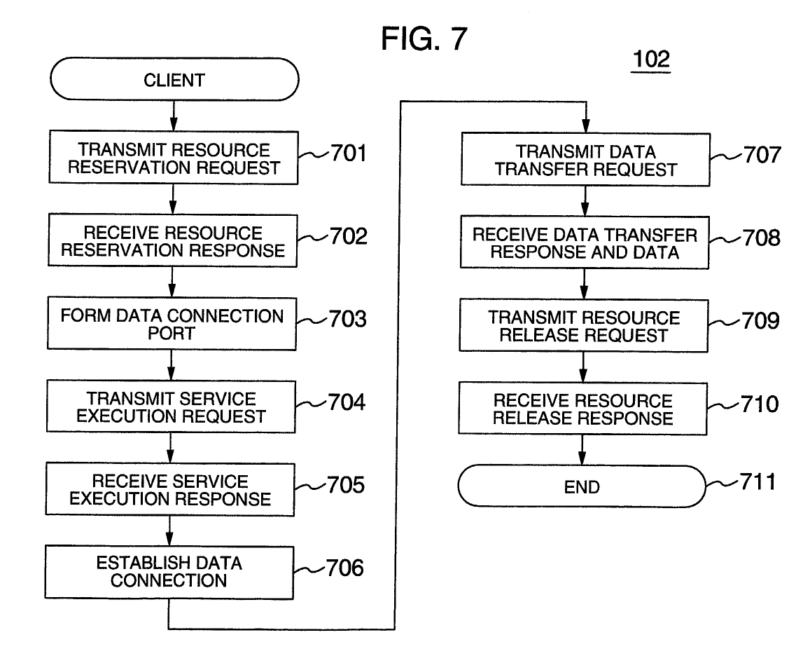

FIGS. 6A to 6C show the data structures of the cache entry register command, cache entry remove command, initialization command and data transfer command 114.

The cache entry register (remove) command 601 is constituted of: a field for distinguishing between the cache entry register command and remove command; a service type, the quality of services provided, and service parameters; and data (to be cached).

The initialization command 602 is constituted of: a field for identifying the initialization command; a client IP address and a data connection client port number; and a necessary disc bandwidth, a necessary network bandwidth and a necessary CPU time.

The data transfer command 603 is constituted of: a field for identifying the data transfer command; a client IP address and a data connection client port number; an I/O engine IP address and a data connection server port number; and a service type, the quality of services provided and service parameters.

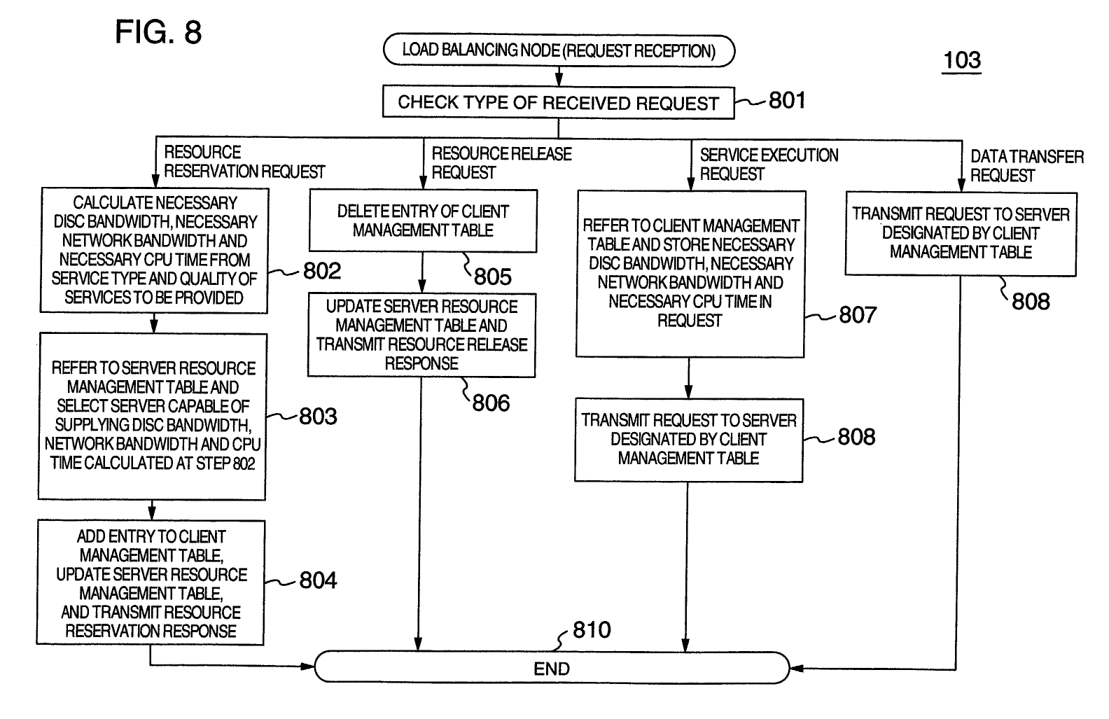

FIG. 7 is a flow chart illustrating the operation of the client 102.

Prior to the service execution request to the server, the client first requests for the reservation of resources necessary for transferring data of service execution results.

Specifically, the client transmits a resource reservation request 501 to the load balancing node (Step 701). The client then receives the resource reservation result as the resource reservation response 501 (Step 702). The information of the client IP address, service type, quality of services to be provided, which information is to be included in the resource reservation request, is determined and set by the client.

Next, the client forms a data connection port (Step 703).

The client issues the service execution request 503 relative to the server. Specifically, the client transmits the service execution request to the load balancing node 103 (Step 704), and receives the results as the service execution response 503 (Step 705). Only the information to be included in the service execution request, i.e., the client IP address, data connection client port number (of the port formed at Step 703), service type, quality of services to be provided, and service parameters, are determined and set by the client. The other information is not set by the client.

Upon reception of the service execution response, the client establishes a data connection (Step 706). The service execution response received at Step 705 includes information of the terminal point on the data connection I/O engine 104 side (I/O engine IP address and data connection server port number). The client establishes the data connection between the terminal point designated by this information and the port designated at Step 703.

Next, the client transmits a data transfer request 504 to the load balancing node 103 in order to receive the execution results of services requested at Step 704 (Step 707). All the information to be included in this request is determined and set by the client. As the information of the terminal point of the data connection on the client side (client IP address, data connection client port number), the information of the port formed at Step 703 is set. As the information of the terminal point of the data connection on the I/O engine side (I/O engine IP address, data connection server port), the information included in the service execution response received at Step 705 is set. As the request result, the client receives the data transfer response 504 from the load balancing node 103. The client also receives data from the I/O engine 104. (Step 708)

The client received all the data transmits the resource release request 502 to the load balancing node 103 in order to release the reserved resources (Step 709). As this result, the client receives the resource release response 502 (Step 710) to thereafter terminate all the operations (Step 711). The client IP address to be included in the resource release request is determined and set by the client.

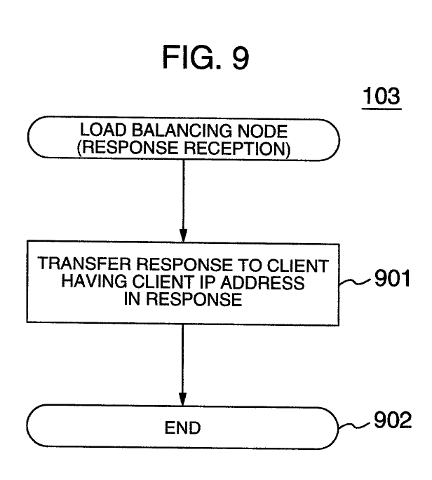

FIGS. 8 and 9 are flow charts illustrating the operation of the load balancing node 103.

In response to the reception of various requests and responses from the clients and servers, the load balancing node 103 starts its operation. The operations of the load balancing node 103 to be executed when various requests are received are illustrated in the flow chart of FIG. 8, whereas the operations of the load balancing node 103 to be executed when various responses are received are illustrated in the flow chart of FIG. 9.

As shown in FIG. 8, upon reception of a request, the load balancing node 103 checks the type of the received request (Step 801) to execute a process corresponding to the request.

When the resource reservation request is received, the load balancing node 103 executes the following processes.

The load balancing node 103 calculates the disc bandwidth, network bandwidth and CPU time necessary for transmitting data of service execution results, from the service time and the quality of services to be provided included in the resource reservation request 501 (Step 802).

Next, the load balancing node 103 refers to the server resource management table. In accordance with the maximum amounts and use amounts of the disc bandwidth, network bandwidth and CPU time 202 to 207 stored in the table, the load balancing node 103 determines the I/O engine 104 capable of supplying the resource amount calculated at Step 802 and also determines the server of the determined I/O engine 104. (Step 803)

Lastly, the load balancing node 103 adds an entry to the client management table.

The information 301 to 307 in the client management table is set in the following manner.

The information 501 included in the resource reservation request is set to the client IP address, service type and the quality of services to be provided.

The values calculated at Step 802 are set to the necessary disc bandwidth, necessary network bandwidth, and necessary CPU time.

The server IP address set at Step 803 is set to the server IP address.

After the entry addition to the client management table is completed, the load balancing node 103 updates the use amounts 203, 205 and 207 in the server resource management table. Next, the load balancing node 103 returns the resource reservation response 501 to the client. The information set to the resource reservation response is quite the same as the information in the received resource reservation request. (Step 804)

The load balancing node 103 received the resource release request executes the following processes.

The load balancing node 103 removes the entry of the client management table having the same value as the client IP address contained in the resource release request 502. (Step 805)

The load balancing node 103 updates the use amounts 203, 205 and 207 of various resources in the server resource management table. Thereafter, the load balancing node 103 returns the resource release response 502 to the client. The information set to the resource release response is quite the same as the information in the received resource release request. (Step 806)

The load balancing node 103 received the service execution request executes the following processes.

The load balancing node 103 searches the entries 301 to 307 of the client management table having the same value as the client IP address contained in the service execution request 503. The load balancing node 103 sets the values stored in the fields 304 to 306 of the necessary disc bandwidth, necessary network bandwidth and necessary CPU time to the received resource reservation request. (Step 807)

The load balancing node 103 transfers the resource reservation request set at Step 807 to the server (step 808).

The load balancing node 103 received the data transfer request executes the following processes.

The load balancing node 103 searches an entry of the client management table having the same value as the client IP address contained in the data transfer request 504. The load balancing node 103 transmits the received data request to the server designated by the server IP address field 307 of the searched entry. (Step 809)

As shown in FIG. 9, when various responses are received, the load balancing node 103 transmits the responses to the clients. In this case, the destination client is determined from the client IP address in each of various responses 501 to 504.

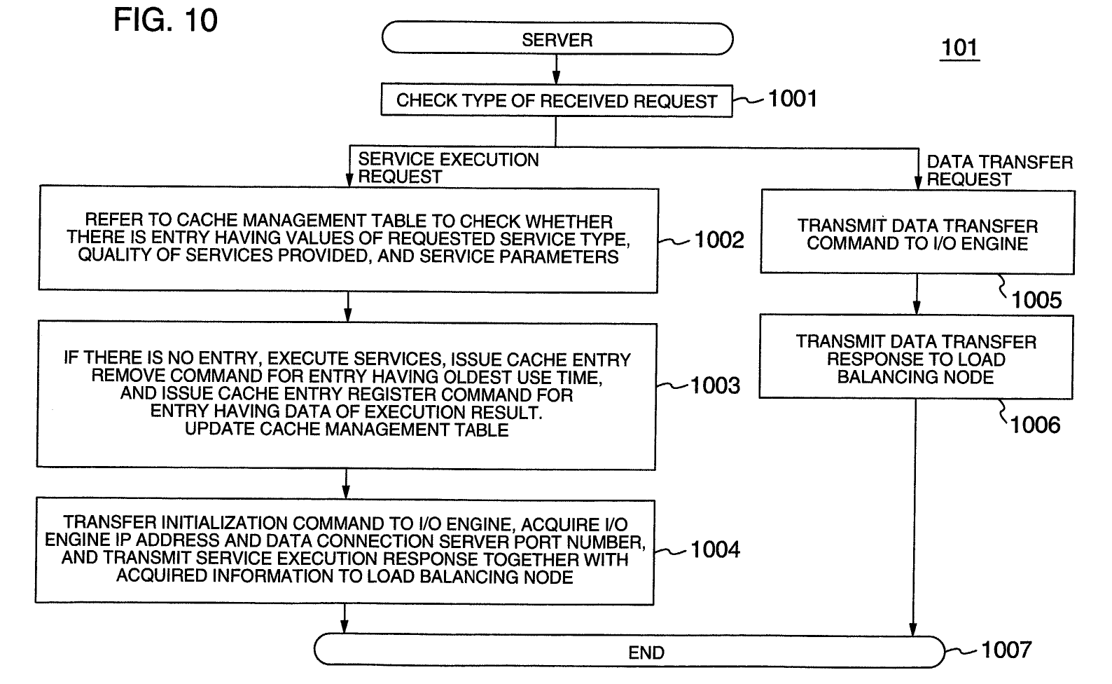

FIG. 10 is a flow chart illustrating the operation of the server 101.

The server checks the type of the received request (Step 1001) to execute the process corresponding to the request. The server starts operations when a service execution request or a data transfer request is received from the load balancing node 103.

The server received the service execution request executes the following processes.

The server refers to the cache management table 401 to 404 to check whether there is an entry having the same values as the information identifying the cache contents in the received service execution request 503 (service type, the quality of services provided, service parameters) (Step 1002).

If there is no entry, the server executes services in accordance with the information identifying the cache contents in the service execution request 503. The server makes the caching storage device 105 of the I/O engine 104 cache the data of execution results. If the capacity of the caching storage device 105 is insufficient for caching the data, the server issues a cache entry remove command to the I/O engine 104. Cache data to be removed is determined by searching the entry having the oldest time stored in the current time field 404 of the cache management table. The information identifying the cache contents in the entry is included in the cache entry remove command 601 to be transmitted. The server transmitted the cache entry remove command removes the entry of the cache management table.

The server generates a cache entry register command 601 and transmits it to the I/O engine 104, the entry having the information identifying the cache contents in the received service execution request and the data of service execution results, and transmits it to the I/O engine 104. The server generates an entry of the cache management table having the above-described information and registers it. A time when the process is executed is stored in the use time field of the generated entry. If it is judged at Step 1002 that there is an entry, the server executes only a process of updating the use time field of the entry in the cache management table to the current time. (Step 1003)

The server transmits an initialization command 602 to the I/O engine 104. As the information to be included in the initialization command, the information in the received service execution request is copied. With this initialization command, the server acquires the information designating the terminal point of the data connection on the I/O engine side (I/O engine IP address, data connection server port number). The server adds the acquired information to the service execution response 503 and transmits it to the load balancing node 103. (Step 1004)

The server received the data transfer request executes the following processes.

The server issues the data transfer command 603 to the I/O engine 104. The information to be included in the data transfer command is the same as the information in the data transfer request received by the server. (Step 1005)

The server transmits the data transfer response 504 to the load balancing node 103. The information to be included in the data transfer response is the same as the information in the data transfer request received by the server. (Step 1006)

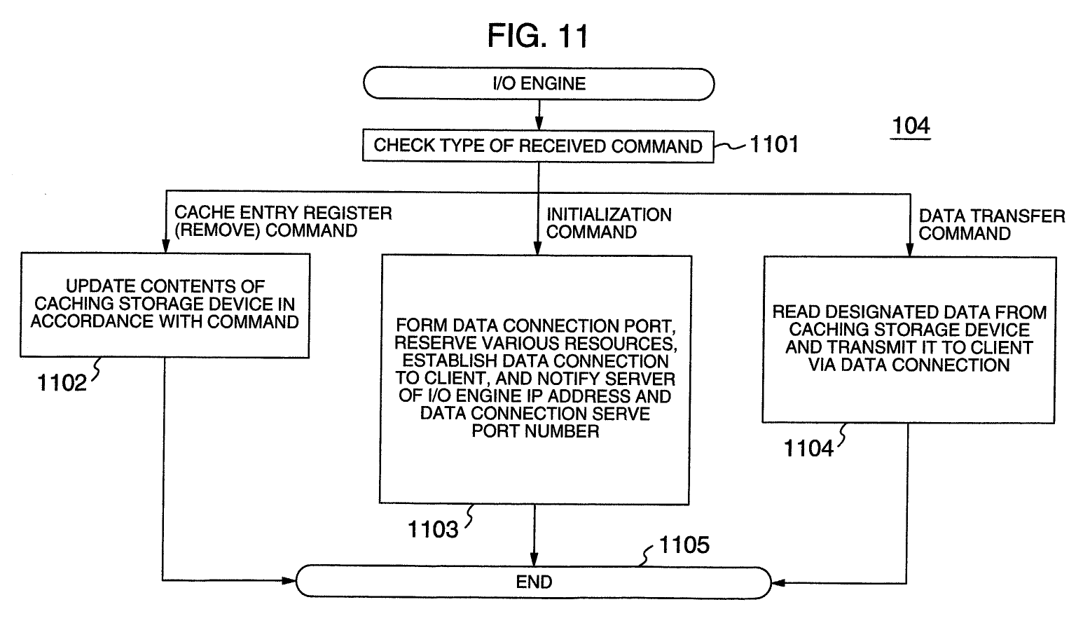

FIG. 11 is a flow chart illustrating the operation of the I/O engine 104.

The I/O engine 104 starts operations when various command are received from the servers. The I/O engine 104 checks the type of a received command (Step 1101) to execute a process corresponding to the command.

The I/O engine 104 received the cache entry register (remove) command executes the following processes.

In accordance with the received cache entry register (remove) command, the I/O engine 104 registers (removes) the entry of the caching storage device 105 (Step 1102).

The I/O engine 104 received the initialization command executes the following processes.

After the I/O engine 104 forms a data connection port, it establishes the data connection to the client. The data connection destination is determined from the initialization command 602 including the information designating the terminal point of the data connection on the client side (client IP address, data connection client port number). The I/O engine further reserves the disc bandwidth, network bandwidth and CPU time included in the initialization command. Lastly, the I/O engine notifies the server of the information designating the terminal point of the data connection on the I/O engine side (I/O engine IP address, data connection server port number). (Step 1103)

The I/O engine 104 received the data transfer command executes the following processes.

The I/O engine 104 determines cached data corresponding to the information designating the cache contents in the received data transfer command 603. The I/O engine 104 then reads the cached data from the caching storage device, and transmits it to the client via the data connection established at Step 1103. At this Step 1104, the I/O engine uses only the resources reserved at Step 1103.

The invention provides the following advantages:

1) The load balancing node can correctly predict the load of each I/O engine and realize the load distribution in accordance with the prediction;

2) Different priority degrees of the quality of services to be provided can be set to clients; and

3) Since various resources of each I/O engine can be reliably distributed to clients, the quality of services can be guaranteed precisely.

It should be further understood by those skilled in the art that the foregoing description has been made on embodiments of the invention and that various changes and modifications may be made in the invention without departing from the spirit of the invention and the scope of the appended claims.

What is claimed is:

1. Data relay method for a system having a plurality of servers and clients and a load balancing apparatus interconnected by a network, comprising the steps of:
transmitting a request for reserving server resources necessary for receiving services to the load balancing apparatus from a client;
making the load balancing apparatus select a server capable of assigning server resources requested by the client from the plurality of servers in accordance with predetermined information;
transmitting assignment of the server resources requested by the client to the selected server;
transmitting a service execution request received from the client to the selected server; and
making the selected server execute services corresponding to the service execution request from the client, in accordance with the assignment of the server resources transmitted from the load balancing apparatus.

2. Data relay method according to claim 1, further comprising a step of transmitting the request for reserving the server resources to the load balancing apparatus from the client before the client transmits the service execution request.

3. Data relay method according to claim 2, wherein said server selecting step selects one of the plurality of servers in accordance with a priority degree assigned to the client.

4. Data relay method according to claim 3, wherein each of the plurality of servers is connected to a data distribution apparatus, and the data relay method further comprises the steps of:
notifying a portion of the amount of the server resources requested by the client belonging to the data distribution apparatus to the data distribution apparatus from the server; and
making the data distribution apparatus distribute data requested from the client by using the portion of the server resource amount notified by said notifying step.

5. Data relay method according to claim 4, wherein the predetermined information is information for managing a total amount of the server resources reserved to the plurality of servers.

6. Data relay method according to claim 5, wherein the predetermined information includes information for managing the total amount of server resources already reserved by each data distribution apparatus.

7. Load balancing apparatus connected to a first information processing apparatus and a plurality of information processing apparatuses via a network, wherein:
information for reserving resources of the second information processing apparatus is received from the first information processing apparatus;
one of the plurality of second information processing apparatuses is selected in accordance with the received information;
the received information for reserving the resources is transmitted to the selected second information processing apparatus;
a request for receiving services from the second information processing apparatus is received from the first information processing apparatus; and
a request for receiving the services is transmitted to the selected second information processing apparatus.

8. Load balancing apparatus according to claim 7, further comprising information for managing a total amount of resources already reserved for the plurality of information processing apparatuses.

9. Load balancing apparatus according to claim 8, wherein the selected second information processing apparatus is selected in accordance with a priority degree assigned to the first information processing apparatus.

10. Load balancing apparatus according to claim 8, wherein each of the plurality of second information processing apparatuses is connected to a data distribution apparatus, and the information for reserving the resources to be transmitted includes information for reserving resources of the data distribution apparatuses.

11. Information processing system for providing services to a client via a network, wherein:
a request for reserving resources of the information processing system is received from an external;
the resources of the information processing system are reserved in accordance with the request;
a request for receiving services is received from the external; and
services satisfying the request for receiving the services are provided by using the reserved resources.

12. Information processing system according to claim 11, wherein the request for reserving the resources of the information processing system received from the external includes a request for reserving resources of the data distribution apparatus connected to the information processing system.

13. Information processing system according to claim 12, wherein:
the request for reserving the resources of the data distribution apparatus is transferred to the data distribution apparatus; and
a data distribution command is sent to the data distribution apparatus in accordance with the request for receiving the services.
